(19) United States
(12) Patent Application Publication
(10) Pub. No.: US 2025/0148585 A1
(43) Pub. Date: May 8, 2025

(54) METHOD AND DEVICE WITH MULTI-LEVEL SEMICONDUCTOR WAFER DEFECT DETECTION

(71) Applicant: Samsung Electronics Co., Ltd., Suwon-si (KR)

(72) Inventors: Priyadarshini Panemangalore PAI, Suwon-si (KR); Prashant Pandurang SHINDE, Suwon-si (KR); Shashishekara Parampalli ADIGA, Suwon-si (KR)

(73) Assignee: Samsung Electronics Co., Ltd., Suwon-si (KR)

(21) Appl. No.: 18/938,110

(22) Filed: Nov. 5, 2024

(30) Foreign Application Priority Data
Nov. 6, 2023 (IN) 202341075803
Nov. 5, 2024 (KR) 10-2024-0155556

(51) Int. Cl. G06T 7/00

(52) U.S. Cl. CPC G06T 7/0004; G06T 2207/20081; G06T 2207/20084; G06T 2207/30148

(57) ABSTRACT

Disclosed is a multi-level defect detection method and system for detecting one or more defects in semiconductor wafers, including forming, among input images of the semiconductor wafers, a first image set of input images in which defects were not detected and a second image set of input images in which defects were detected; extracting image parameters from the first image set and determining whether the first image set can be enhanced; generating an image enhancement profile for the first image set and modifying the first image set based on the image enhancement profile and detecting one or more defects in the modified image set by performing a defect detection process thereon.

### CROSS-REFERENCE TO RELATED APPLICATIONS

This application claims priority to and the benefit under 35 USC § 119 (a) of Korean Patent Application No. 10-2024-0155556 filed in the Korean Intellectual Property Office on Nov. 5, 2024, and Indian Patent Application number 202341075803 filed in the Indian Patent Office on Nov. 6, 2023, the entire contents of which are incorporated herein by reference.

### BACKGROUND

### 1. Field

The present disclosure relates to the field of semiconductor devices and chips. In particular, the present disclosure relates to a method and device with multi-level semiconductor wafer defect detection.

### 2. Description of Related Art

Growing demand for smartphones, tablets, digital televisions, wireless communication infrastructure, network hardware, computers, and electro-medical devices is contributing significantly to long-term demand for semiconductor chips. These demands, together with continuing efforts to lower costs per wafer and to lower energy consumption, are pushing semiconductor fabrication towards decreased critical dimension and increased circuit intricacy.

Semiconductor wafer nodes (basic circuit units, e.g., transistors) represent a level of miniaturization and precision achieved in manufacturing processes of the semiconductor chips. As semiconductor wafer nodes become smaller, demand for high-precision Artificial Intelligence (AI)-based detection methods is increasing. Any defects or impurities on the surface of a semiconductor wafer's nodes can lead to malfunctioning chips, which ultimately reduces yield rates, increases production costs, and potentially compromises integrity of electronic devices. Ensuring quality and reliability of the semiconductor wafer nodes is therefore important. Detection and elimination of defects in the semiconductor wafer nodes is therefore a prominent endeavor.

Existing wafer defect detection systems detect physical defects and pattern defects on the surface of semiconductor wafer nodes and determine position coordinates of the physical defects and the pattern defects. The detection of physical defects and pattern defects on the surface of a semiconductor wafer's nodes is challenging due to the usually complex topography of lithography patterns of semiconductor wafer nodes and the presence of impurities in materials used for manufacturing semiconductor wafer nodes.

Although various conventional methods for predicting physical defects and pattern defects have been developed over the years, the prediction of physical defects and pattern defects becomes more difficult as the size of each of defects becomes smaller, as the noise in images (for defect detection) of semiconductor wafer nodes increases, and as wafer nodes become increasing heterogeneous, the efficiency of these methods in real-time applications largely depends on the type and quality of input data, in particular the images of semiconductor wafer nodes.

In real-time applications, conventional methods have difficulty selectively applying noise-correction or image enhancement using general or non-specific information. Furthermore, large-scale application may lead conventional methods to poor defect detectability due to loss of information or dilution of distinguishing features from defect regions of semiconductor wafer nodes.

An of conventional pattern defect detection is shown in FIG. 1. The images shown in FIG. 1 have been synthetically generated in real-time after acquiring the images using advanced microscopy techniques such as Scanning Electron Microscopy (SEM). The acquired images are pre-processed and subjected to defect detection/defect review systems. The defect detection/defect review systems have AI models that use synthetically generated images from SEM as inputs and provide the end-user with information such as predicted type and location of defects. Wafer images provided in an incoming pipeline for the detection of defects are heterogeneous with respect to the size of each of the defects and noise levels included in the input images of lithographic line patterns. The prediction quality of a conventional defect detection/review system can vary significantly depending upon the heterogeneity. For example, if the size of defects is critically small, the discriminative features that can be extracted from the corresponding regions of interest can be very inconspicuous, thus potentially resulting in a significant drop in defect detection accuracy, which may be further aggravated if the input images are noisy.

Other conventional methods can also be used for defect detection on noisy input wafer images. For example, an ensemble deep learning-based model shows an improvement in prediction performance by performing a de-noising process over an input wafer image. However, these conventional methods also have limitations, such as inability to identify false negatives. Furthermore, uniformly de-noising an input wafer image can lead to the smoothening of small defects, which adversely affects the defect detection process. In addition, ensemble models consume a large number of resources and create extra overhead during training and inference modelling, especially those using multiple Convolutional Neural Network (CNN) blocks. Thus, memory requirements and processing time can be relatively high.

### SUMMARY

This summary is provided to introduce a selection of concepts in a simplified format that is further described in the detailed description. This summary is not intended to identify key or essential inventive concepts of the present disclosure, nor is it intended to determine the scope of the present disclosure.

In one general aspect, a method for detecting defects in semiconductor wafers includes: receiving, from a user device or an imaging device, input images of the semiconductor wafers; performing, by using a first Artificial Intelligence (AI)-based model, a first defect detection process on the input images to detect defects in the respective input images; collecting, based on a result of the first defect detection process, a first image set and a second image set among the one or more input images, wherein the first image set includes those images among the input images for which no defect was detected in the first defect detection process, and wherein the second image set includes those images among the input images for which any defects were detected in the first defect detection process; generating, by using the second AI-based model, at least one first image enhancement profile for the first image set; modifying, by using a third AI-based model, the first image set based on at least one first image enhancement profile; and performing a second defect detection process on the modified first image set to detect previously undetected defects in the input images in the modified first image set.

The method may further include extracting a first image parameters from the first image set based on an analysis on the first image set using the first AI-based model; determining, by using a second AI-based model, whether any images in the first image set can be enhanced based on the extracted first image parameters; and wherein the generating, by using the second AI-based model, at least one first image enhancement profile for the first image set comprises generating, by using the second AI-based model, at least one first image enhancement profile for the first image set based on a determination that the first image set can be enhanced based on the extracted first image parameters; modifying, by using a third AI-based model, the first image set based on at least one first image enhancement profile; and performing a second defect detection process on the modified first image set to detect previously undetected defects in the input images in the modified first image set.

Performing the first defect detection process may include: extracting a predefined image parameters from each of the input images, wherein each of the extracted predefined image parameters include an image size, an image quality, a region of interest, and/or a noise level of a corresponding input image; and detecting the defects in the input images based on an evaluation of the extracted predefined image parameters.

The modifying the first image set may include: performing, by using the third AI-based model and based on the first image enhancement profile, a restoration process, a de-noising process, and/or a resolution enhancement process on the input images in the first image set.

The method may further include: extracting second image parameters from the second image set based on an analysis on the second image set using the first AI-based model; determining, by using the second AI-based model, whether any images of the second image set can be enhanced based on the extracted second image parameters; generating, by using the second AI-based model, a second image enhancement profile for the second image set based on a determination that the second image set can be enhanced based on the extracted second image parameters; modifying, by using the third AI-based model, the images in the second image set based on the second image enhancement profile; and performing the second defect detection process on the modified second image set to detect previously undetected defects in the modified second image set.

The first image parameters of each image in the first image set may include a resolution, a noise-level, and scale information of a corresponding input image in the first image set, the second of image parameters of each image in the second image set includes a resolution, a noise-level, and scale information of a corresponding input image in the second image set, and the extracted first image parameters are different from the extracted second image parameters.

The method may further include: determining, by using the second AI-based model, whether the modified first image set can be further enhanced, wherein the modified first image set includes only input images for which defects have not been detected in the second defect detection process; re-generating, by using the second AI-based model, based on a determination that the modified first image set can be further enhanced, a third image enhancement profile for the modified first image set by extracting the first image parameters from the modified first image set; re-modifying, by using the third AI-based model, the modified first image set based on the regenerated image enhancement profile; and performing a third defect detection process on the re-modified first image set to detect previously undetected defects in the input images in the re-modified first image set.

The defects may include holes, breaks, bridges, gaps, line collapse, missing pillars, and/or scum, in a wafer lithographic pattern, and the wafer lithographic pattern may include line spaces, holes, or pillars in the images of the semiconductor wafers.

The first AI-based model and the second AI-based model may respectively include rule-based learning models, and the third AI-based model may correspond to a neural network model configured to perform image enhancement.

In another general aspect, an apparatus for multi-level defect detection in semiconductor wafers includes: a memory; and one or more processors communicatively coupled with the memory, wherein the memory stores instructions configured to cause the one or more processors to perform a process including: receiving input images of the semiconductor wafers; performing, by using a first AI-based model, a defect detection process on the input images to detect defects in the input images; based on a result of the defect detection process, forming a first image set to include those of the input images for which no defects were detected and forming a second image set to include those of the input images for which any defects were detected; generating, by using the second AI-based model, an image enhancement profile for the first image set; modifying, by using a third AI-based model, the first image set, the modifying performed according to the generated image enhancement profile; and re-performing the defect detection process on the modified first image set to detect one or more previously undetected defects in the modified first image set.

The process may further include extracting a first image parameters from the input images in the first image set based on an analysis of the first image set, the analysis performed by the first AI-based model; determining, by using a second AI-based model, whether to perform image enhancement on the first image set, and wherein the generating, by using the second AI-based model, an image enhancement profile for the first image set comprises
generating, by using the second AI-based model, the image enhancement profile for the first image set based on a determination that enhancement is to be performed on the first image set.

Modifying the first image set may include: performing, by using the at least one third AI-based model and based on the generated image enhancement profile, a restoration process, a de-noising process, and/or a resolution enhancement process on the images in the first image set.

The process may further include: extracting second image parameters from the second image set based on an analysis of the second image set performed by the first AI-based model; determining, by using the second AI-based model, whether to perform image enhancement on the second image set; generating, by using the second AI-based model, an image enhancement profile for the second image set based on a determination to perform image enhancement on the second image set; performing the image enhancement, by using the third AI-based model, on the second image set, the image enhancement based on the generated image enhancement profile of the second image set; and re-performing the defect detection process on the enhanced second image set to detect previously undetected defects in the enhanced second image set.

The first image parameters may include a resolution, a noise-level, scale information of each of the images in the first image set, and the second image parameters may include a resolution, a noise-level, scale information of each of the images in the second image set, and the extracted first image parameters is different from the extracted second image parameters.

The process may further include: determining, by using the second AI-based model, whether the enhanced first image is to be further enhanced, wherein the enhanced image set corresponds to images in which defects have not been detected in the second defect detection process; re-generating, by using the second AI-based model, based on a determination that the modified first image set is to be further enhanced, an image enhancement profile for the enhanced first image set by extracting the first image parameters from the enhanced first image set; re-enhancing, by using the third AI-based model, the enhanced first image set based on the regenerated image enhancement profile; and re-performing the defect detection process on the re-enhanced first image set to detect previously undetected defects in the re-enhanced first image set.

The one or more defects may include holes, breaks, bridges, gaps, line collapse, missing pillars, and/or scum, in wafer lithographic patterns, and the wafer lithographic pattern may include line spaces, holes, and/or pillars in the input images.

In another general aspect, a method includes: applying a defect detection process to a set of images of semiconductor wafers; dividing the input images into a first image set consisting of those of the images for which the defect detection process did not detect any defects and a second image set consisting of those of the images for which the detect detection process detected any defects; extracting first image parameters from the first image set and extracting second image parameters from the second image set; determining a first image-enhancement profile based on the first image set and determining a second image-enhancement profile based on the second image set; applying an image-enhancement process to the first image set according to the first image-enhancement profile; applying the image-enhancement process to the second image set according to the second image-enhancement profile; applying the defect detection process to the enhanced first image set and applying the defect detect process to the enhanced second image set; and eliminating from the enhanced first image set any images thereof for which the second application of the defect detection process did not detect any defects, generating a new first image-enhancement profile for the thus-reduced enhanced first image set, and applying the defect detection process thereto.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example of various kinds of defects detected in an image of a semiconductor wafer;

FIG. 2 illustrates a system for performing multi-level defect detection in a semiconductor wafer, according to one or more embodiments; and

FIGS. 3-5 illustrate a detailed multi-level defect detection method for detecting one or more defects in input images of a semiconductor wafer, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

The terms “input”, “input images”, “input wafer images”, and “input semiconductor wafer images” are used interchangeably throughout the description.

Some embodiments described herein may perform multi-level semiconductor wafer defect detection, where images of a semiconductor wafer are subjected to a semiconductor wafer defect detection system, then, as needed, the images are subjected to iterative enhancement followed additional detection by the semiconductor wafer defect detection system, until a desirable outcome is achieved.

An artificial intelligence (AI) model, e.g., a neural network, may be a machine learning model that learns at least one task, and can be implemented as a computer program (instructions) executed by a processor. A task learned by an artificial intelligence model is a task to be solved through machine learning or a task to be performed through machine learning. Artificial intelligence models can be implemented as computer programs (instructions) running on computing devices, downloaded over a network, or sold in product form. Alternatively, the artificial intelligence model can link with various devices through a network.

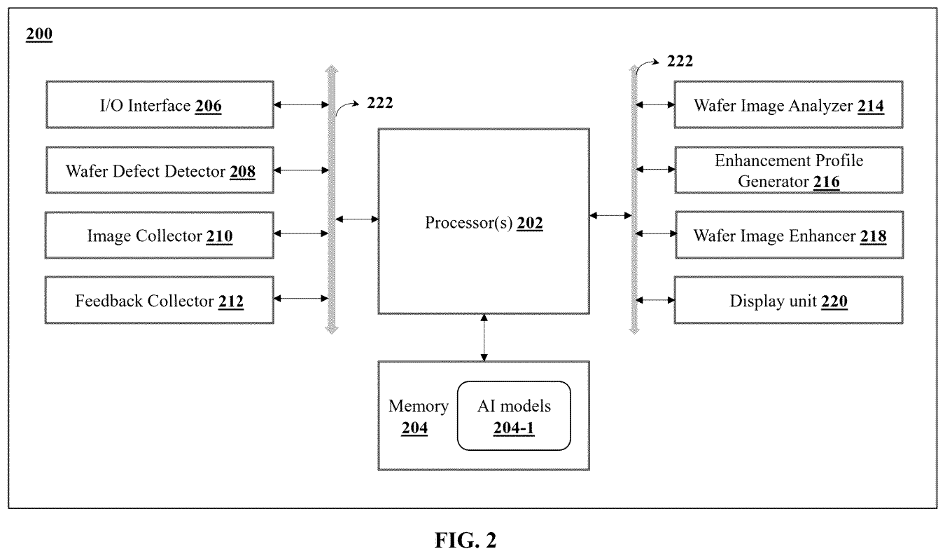

FIG. 2 illustrates a system 200 for performing multi-level defect detection on a semiconductor wafer, according to one or more embodiments. The system 200 may include a processor(s) 202 (may also be referred to as “one or more processors 202” or “at least one processor 202”), a memory 204, an Input/Output (I/O) interface 206, a wafer defect detector 208, an image collector 210, a feedback collector 212, a wafer image analyzer 214, an enhancement profile generator 216, a wafer image enhancer 218, a display unit 220, and one or more interconnect bus 222.

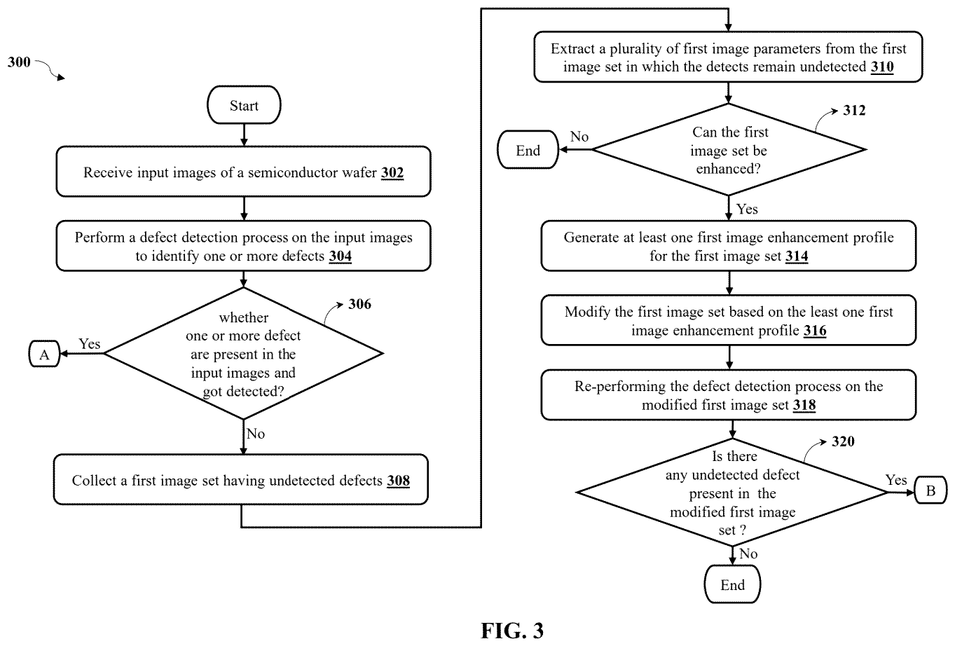

The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 may be configured to fetch and execute computer-readable instructions and data stored in the memory 204. The processor 202 may be a general-purpose processor, such as a central processing unit (CPU), an application processor (AP), or the like, and an AI-dedicated processor such as a neural processing unit (NPU). The processor 202 may control the processing of input data in accordance with a predefined operating rule or AI model stored in the non-volatile memory and the volatile memory, i.e., the memory 204. The predefined operating rule or artificial intelligence model may be configured through training or learning. The processor 202 may be operatively coupled to each of the memory 204, the I/O interface 206, the wafer defect detector 208, the image collector 210, the feedback collector 212, the wafer image analyzer 214, the enhancement profile generator 216, the wafer image enhancer 218, and the display unit 220 via the one or more interconnect bus 222. The processor 202 may be configured to process, execute, or perform operations described herein below in conjunction with FIGS. 3-5 of the drawings. Although some units in FIG. 2 are shown as separate from the processor 202, in practice, some units, or portions thereof, may be executed by the processor 202.

The memory 204 may include any non-transitory computer-readable medium for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 204 may be communicatively coupled with the processor 202 to store processing instructions configured to cause the processor 202 to perform a process described herein. The memory 204 may include an operating system for performing one or more tasks of the system 200, as performed by a generic operating system in a computing domain. The memory 204 may include AI-based models 204-1. The AI-based models 204-1 may include a first AI-based model, a second AI-based model, and a third AI-based model. The first and second AI-based models may be rule-based learning models. The third AI-based model may be a deep learning-based model.

The I/O interface 206 may be hardware or software components that enable data communication in the system. The I/O interface 206 may serve as a communication medium for exchanging information, commands, or data among the various units of the system. The I/O interface 206 may be a part of the processor 202 or maybe a separate component. The I/O interface 206 may be created in software or maybe a physical connection in hardware. The I/O interface 206 may be configured to connect with the display unit 220, or any other units of the system thereof. The I/O interface 206 may include an image acquisition unit and a reporting unit. The image acquisition unit may receive input images of the semiconductor wafer from a user device or an imaging device. For example, the input images of the semiconductor wafer may be acquired using advanced microscopy techniques like Scanning Electron Microscopy (SEM). The input images of the semiconductor wafer obtained by SEM or by some other techniques may be provided in the wafer defect detector. The reporting unit in I/O interface 206 may share the prediction of the defect detection in the semiconductor wafer as an output.

The wafer defect detector 208 may preprocess the input images of the semiconductor wafer to check the size and the basic quality of each input image. An evaluation may be performed based on dimension requirements, regions of interest, noise, etc. in the input images. After the evaluation on the input images, evaluated image parameters including resolution, noise-levels, scale information, and/or the like may be collected and stored in the memory 204. The preprocessed input images may be provided to the wafer defect detector 208 for detecting if the preprocessed input images have any indications of defects (“defects” for short). The wafer defect detector 208 may detect locations of respective defects in the preprocessed input images. However, depending upon the size, noise levels, etc., of the defects, some defects may remain undetected in the preprocessed input images at the stage of wafer defect detection. Hereafter, the “preprocessed” qualification of the input images is omitted with the understanding that the input images have been preprocessed.

The image collector 210 may collect the output of the wafer defect detector 208 for classification of the input image. In some embodiments, the output of the wafer defect detector 208 may include input images that do not have any defects or the input images where the defects remain undetected. The input images that have no defect or that have an undetected defect may be collected as a first image set by the image collector 210. Further, the collected output of the wafer defect detection also includes input images with defects. The input images having defects may be collected as a second image set by the image collector 210.

The feedback collector 212 may perform a review of the output of the wafer defect detector 208. The review of the output of the wafer defect detector 208 may be performed by an AI-based model that analyzes the one or more input images of the semiconductor wafer. As a result of the review of the output of the wafer defect detector 208, the feedback collector 212 may extract first image parameters from the first image set, and may further extract second image parameters from the second image set. The first image parameters and the second image parameters may include resolution, noise-levels, scales, etc. of the images in the first image set and the second image set. Further, the extracted first image parameters may be different from the extracted second image parameters

The wafer image analyzer 214 may analyze the image parameters collected by the feedback collector 212. The collected image parameters may be used to determine what a most likely cause of a failure in detecting the defects in the first image set and the second image set. The causes of failure in detecting the defect in the first image set and the second image set may be noisy input images, input images having very low resolution, or input images that contain defects the scope of the model's training, etc.

As a result of the analysis performed by the wafer image analyzer 214, the enhancement profile generator 216 may determine, by using the second AI-based model, whether the first image set, the second image set, or both can be enhanced based on the extracted first image parameters and the second image parameters, respectively. For example, the second AI-based model may output a score (scalar value) or a vector indicating yes or no of the likelihood of the enhancement of the image set regarding whether the first image set can be enhanced from the input first image parameters. As the rule-based learning model, the second AI-based model may be trained to determine the likelihood of the enhancement of the image set based on a rule including, for example, a threshold of a noise level at which images in the image set cannot be enhanced. Based on the determination of whether the first image set, the second image set, or both can be enhanced, the enhancement profile generator 216 may generate an image enhancement profile for the first image set, the second image set, or both using the second AI-based model. For example, the second AI-based model may output the first image enhancement profile for the first image set and the second image enhancement profile for the second image set, respectively, based on the input of the first image parameters and the input of the second image parameters. The generation of the image enhancement profile may include, for example, a restoration process, a de-noising process, a de-blurring process, and/or a resolution enhancement process, etc.

The wafer image enhancer 218 may modify or enhance the first image set, the second image set, or both, by using the third AI-based model based on an image enhancement profile generated for the first image set and/or second image set. Accordingly, the wafer image enhancer 218 may generate a modified first image set and/or a modified second image set based on the modification or enhancement of the first image set and/or the second image set. Further, once the modified first image set and/or modified second image set are generated, the wafer image enhancer 218 may provide the modified first image set and/or modified second image set to the wafer defect detector 208.

The display unit 220 may be configured to display the content generated by one or more units or components of the system 200. The display unit 220 may include a display screen. In a non-limiting example, the display screen may be Light Emitting Diode (LED), Liquid Crystal Display (LCD), Organic Light Emitting Diode (OLED), Active Matrix Organic Light Emitting Diode (AMOLED), or Super Active Matrix Organic Light Emitting Diode (AMOLED) screen. The display screen may be of varied resolutions.

FIGS. 3-5 illustrate a multi-level defect detection method for detecting one or more defects in input semiconductor wafer images, according to one or more embodiments.

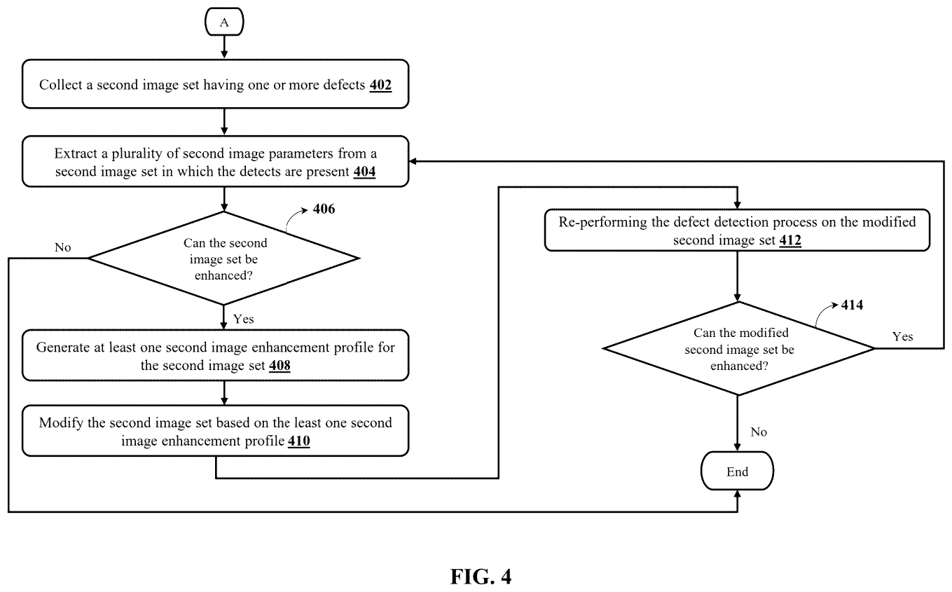

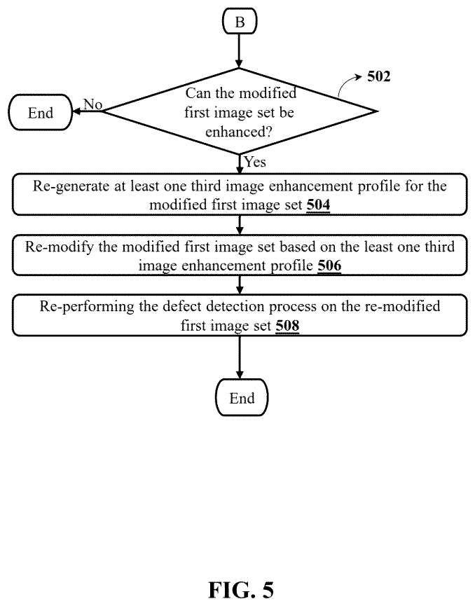

The multi-level defect detection method 300 (also referred to as “method 300”) may include a series of operation steps from 302 to 320 in FIG. 3, from 402 to 414 in FIG. 4, and from 502 to 508 in FIG. 5, respectively. The operations included in the method 300 may be performed by the one or more components of the system 200, where the processor 202 may control each of the respective components of the system 200 using the instructions and the one or more AI-based models stored in the memory 204. The method 300 begins at step 302.

At step 302, the processor 202 may receive the input images of semiconductor wafer(s) from one of the user device or the imaging device. In some implementations the input images may be of one semiconductor wafer, and in other implementations the input images may be of multiple semiconductor wafers (in some cases, each wafer may have multiple input images thereof). For convenience, only the non-limiting case of images of multiple wafers is described below.

At step 304, the processor 202 may perform the defect detection process using the first AI-based model, on the input images to detect defects in the input images. In some embodiments, the processor 202 may perform the defect detection process by extracting the predefined image parameters from each of the input images. The predefined image parameters may include a size of the semiconductor wafers, the image quality, the regions of interest in each of the input images, and/or the noise level of each of the input images. The processor 202 may detect defects in the input images based on an evaluation on the extracted image parameters.

In one or more embodiments, the defects may correspond to holes, breaks, bridges, gaps, line collapse, missing pillars, or scum, in wafer lithographic patterns, to name some non-limiting examples. The wafer lithographic patterns may include line spaces, holes, or pillars captured in images of the semiconductor wafers.

At step 306, the processor 202 may determine whether any defects included in the input images were detected in the defect detection process performed at step 304. In particular, at step 306, the processor 202 may determine, by using the first AI-based model, whether defects present in the input images were detected or not. If, at the step 306, it is determined that defects in any of the input images were detected at step 304 (i.e., whether any of the input images belong in the second image set) then, the flow of the method 300 may proceed to ‘A’ which is further described below in conjunction with FIG. 4. However, if at the step 306, it is determined that no defects in the input images were detected in the step 304, then the flow of the method proceeds to step 308.

At the step 308, the processor 202 may collect the input images for which defects were not detected into the first image set. In the images included in the first image set, any defects remain undetected, based on the negative result of the defect detection process performed on the input images at step 306.

At step 310, the processor 202 may extract the image parameters from the first image set. In one or more embodiments, the first image parameters may include, for example, a resolution, a noise-level, and/or scale information of each of image in the first image set.

At step 312, the processor 202 determines, by using the second AI-based model, whether the first image set can be enhanced based on the extracted first image parameters. Images in the first image set determined to be unable to be enhanced may be designated as images that cannot be modified further to enhance defect detection. Such images may be removed from the further use in the defect detection process. However, if at the step 312, it is determined that images in the first image set can be enhanced, then such images in the first image are used in step 314. They can be enhanced using image enhancement techniques such as denoising, deblurring, super-resolution, etc.

At step 314, the processor 202 may generate, by using the second AI-based model, a first image enhancement profile for the first image set.

At step 316, the processor 202 may modify, by using a third AI-based model, the first image set based on the first image enhancement profile generated for the first image set. The processor 202 may modify the first image set by performing, according to the first image enhancement profile, the restoration process, the de-noising process, and/or the resolution enhancement process on the images remaining in the first image set. In other words, the processor 202 may modify, by using the at least one third AI-based model, the images in the first image set, and the modifying may be based on the first image enhancement profile.

At step 318, the processor 202 may re-perform the defect detection process on the modified first image set; the first AI-based model may be used to detect defects in the images included in the modified first image set.

At step 320, the processor 202 may determine whether any previously-undetected defect is present in the modified first image set of the semiconductor wafers based on the re-performed defect detection process. If, at step 320, it is determined that defects are present in the modified first image set, then the flow of the method 300 proceeds to flow ‘B’ which described below in conjunction with FIG. 5. However, if, at the step 320, it is determined that no defect is detected or identified in the modified first image set of the semiconductor wafers, then the defect detection process comes to an end.

As described above, the system 200 for the multi-level defect detection can increase the accuracy of defect detection using fewer computing resources by enhancing the first image set having undetected defects in the former defect detection process based on the first image enhancement profile and performing the defect detection process again on the enhanced first image set.

FIG. 4 illustrates the method for multi-level defect detection for detecting defects in the second image set of the semiconductor wafers, according to one or more embodiments.

When, at step 306 in FIG. 3, it is determined that defects are present in any of the input images, those input images having the defects are classified into the second image set. In this case, the flow of the defect detection process proceeds to step 402 in FIG. 4. At step 402, the processor 202 may collect the second image set. In the images included in the second image set, the defects thereof have been detected based on the result of the performed defect detection process at step 306 of FIG. 3.

At step 404, the processor 202 may extract the second image parameters from the second image set based on an analysis on the images in the second image set. In one or more embodiments, the second image parameters may include, for example, the resolution, the noise-level, and/or the scale information of each of images in the second image set.

At step 406, the processor 202 may determine, by using the second AI-based model, whether the second image set can be enhanced based on the extracted second image parameters. If it is determined that images in the second image set cannot be enhanced, then such images in the second image set may be removed from further use in the defect detection process. However, if, at step 406, it is determined that images in the first image set can be enhanced, then such second image set proceeds to step 408. Based on the generated enhancement profile, the second image set can be enhanced using one or more techniques of denoising, deblurring, super-resolution, etc.

At step 408, the processor 202 may generate, by using a second AI-based model, at least one second image enhancement profile for the second image set, responsive to the determination that the second image set can be enhanced, and the generation of the second image enhancement profile may be based on the extracted second image parameters.

At step 410, the processor 202 may modify, by using at least one third AI-based model, the images in the second image set based on the second image enhancement profile. In one or more embodiments, the processor 202 may modify the images in the second image set by performing the restoration process, the de-noising process, and/or the resolution enhancement process on the second image set, according to the second image enhancement profile. That is, the processor 202 may modify the second image set, by using the at least one third AI-based model, based on the second image enhancement profile.

At step 412, the processor 202 may re-perform the defect detection process on the modified second image set to detect any additional defects in the modified second image set.

At step 414, the processor 202 may determine whether the modified second image set of the semiconductor wafers can be enhanced. If, at step 414, it is determined that the second image set (or any images therein) can be enhanced, then the flow of the method 300 proceeds to step 404 in FIG. 4. However, if, at step 414, it is determined that the modified second image set cannot be enhanced, then no further processing will take place for the modified second image set.

As described above, the system 200 for multi-level defect detection can increase the accuracy of further (repeated) defect detection while using fewer computing resources by (i) enhancing the second set of images which have defects detected in the earlier defect detection process (the enhancing based on the second image enhancement profile) and by (ii) performing the defect detection process again on the enhanced second image set.

FIG. 5 illustrates the method for enhancing the modified first image set of the semiconductor wafers, according to one or more embodiments.

As a result of step 320 in FIG. 3 where it is determined that there are any images in the modified first image set for which no defects were detected of the semiconductor wafers, then the flow of the method 300 proceeds to step 502 in FIG. 5. At step 502, the processor 202 may determine, by using the second AI-based model, whether the modified first image set has any images that can be further enhanced or not. The modified first image set may or may not include images for which the no defects have been detected in the past defect detection processes on the first image set. If, at step 502, it is determined that the modified first image set cannot be enhanced (it has no images that can be enhanced), then defect detection process comes to an end. Accordingly, the defect detection process will terminate for such images (thus reducing the modified first image set to including only images eligible for further enhancement and for which no defects have yet been detected). However, if, at step 502, it is determined that there are any images among the modified first image set that can be enhanced, then the flow of the method 300 including proceeds to the step 504.

At step 504, the processor 202 may re-generate, by using the second AI-based model, a third image enhancement profile for the modified first image set by extracting the first image parameters from the modified (and possibly reduced, from removal of un-enhanceable images) first image set. In one or more embodiments, the image parameters may include the resolution, the noise-level, and the scale information of each of images still included in the possibly-further-reduced modified first image set.

At step 506, the processor 202 may re-modify, by using the at least one third AI-based model, the modified first image set based on the third image enhancement profile regenerated for (and from) the modified first image set. In one or more embodiments, the processor 202 may further modify the modified first image set by performing, according to the third image enhancement profile, the restoration process, the de-noising process, and/or the resolution enhancement process on the modified first image set. That is, the processor 202 may modify the modified first image set, by using the at least one third AI-based model, based on the third image enhancement profile.

At step 508, the processor 202 may re-perform the defect detection process on the remodified first image set to detect defects in the remodified first image set.

To summarize, an initial set of input images of wafers may be iteratively checked for defects, divided into defect and non-defect sets, and the defect and non-defect sets may be respectively winnowed (of defect images), enhanced if possible, and re-valuated for defects. This may repeat until there are no images left that can be enhanced or that have had no defects detected. With a decreasing amount of images, subsequent processing (e.g., enhancement and reanalysis) consumes less resources.

As described above, the system 200 for the multi-level defect detection can increase the accuracy of further defect detection using less computing resources by performing the defect detection process on the re-modified first image set of the semiconductor wafers followed by the defect detection process on the modified first image set.

Referring to the technical abilities and effectiveness of the above-disclosed method and system, the above-disclosed method and system may, according to implementation, provide the technical improvements like performing a selective input image enhancement of input images of the semiconductor wafers in order to detect the defects that remain undetected even after a single instance of defect detection process is performed. Further, one or more techniques described in the above-disclosed method can be applied to the input images of the semiconductor wafers based on defect detection requirements in the input images of the semiconductor wafers. Furthermore, the application of the above-disclosed method and system can be applied on a large number of input images of the semiconductor wafers altogether, which can lead to efficient defect detection in the input images of the semiconductor wafers. Incidentally, one or more images may be associated with a particular wafer, allowing defect detection to be traced back to particular wafers, thus allowing quality control, improvement/adaptation of the manufacturing process, and so forth.

Although specific units/modules have been illustrated in the figure and described above, it should be understood that the system 200 may include other hardware modules or software modules or combinations as may be required for performing various functions.

The various embodiments described above should not be construed to limit the scope of the disclosure. Various modifications and changes may be made to the principles described herein without following the example embodiments and applications illustrated and described herein, and without departing from the spirit and scope of the disclosure.

Those skilled in the art will appreciate that the operations described herein in the present disclosure may be carried out in other specific ways than those set forth herein without departing from essential characteristics of the present disclosure. The above-described embodiments are therefore to be construed in all aspects as illustrative and not restrictive. The scope of the present disclosure should be determined by the appended claims, not by the above description, and all changes coming within the meaning of the appended claims are intended to be embraced therein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

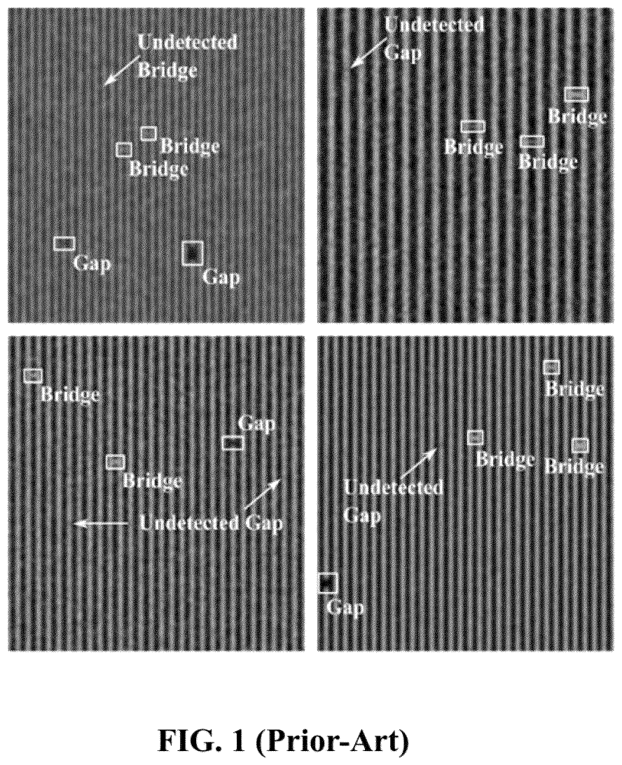

The computing apparatuses, the vehicles, the electronic devices, the processors, the memories, the image sensors, the displays, the information output system and hardware, the storage devices, and other apparatuses, devices, units, modules, and components described herein with respect to FIGS. 1-5 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROM, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method for detecting defects in semiconductor wafers, the method comprising:
receiving, from a user device or an imaging device, input images of the semiconductor wafers;
performing, by using a first Artificial Intelligence (AI)-based model, a first defect detection process on the input images to detect defects in the respective input images;
collecting, based on a result of the first defect detection process, a first image set and a second image set among the one or more input images, wherein the first image set includes those images among the input images for which no defect was detected in the first defect detection process, and wherein the second image set includes those images among the input images for which any defects were detected in the first defect detection process;
generating, by using the second AI-based model, at least one first image enhancement profile for the first image set;
modifying, by using a third AI-based model, the first image set based on at least one first image enhancement profile; and
performing a second defect detection process on the modified first image set to detect previously undetected defects in the input images in the modified first image set.

2. The method of claim 1, further comprising:
extracting a first image parameters from the first image set based on an analysis on the first image set using the first AI-based model; and
determining, by using a second AI-based model, whether any images in the first image set can be enhanced based on the extracted first image parameters, and wherein the generating, by using the second AI-based model, at least one first image enhancement profile for the first image set comprises
the generating, by using the second AI-based model, at least one first image enhancement profile for the first image set based on a determination that the first image set can be enhanced based on the extracted first image parameters.

3. The method of claim 1, wherein performing the first defect detection process comprises:
extracting a predefined image parameters from each of the input images, wherein each of the extracted predefined image parameters include an image size, an image quality, a region of interest, and/or a noise level of a corresponding input image; and
detecting the defects in the input images based on an evaluation of the extracted predefined image parameters.

4. The method of claim 1, wherein the modifying the first image set comprises:
performing, by using the third AI-based model and based on the first image enhancement profile, a restoration process, a de-noising process, and/or a resolution enhancement process on the input images in the first image set.

5. The method of claim 1, further comprising:
extracting second image parameters from the second image set based on an analysis on the second image set using the first AI-based model;
determining, by using the second AI-based model, whether any images of the second image set can be enhanced based on the extracted second image parameters;
generating, by using the second AI-based model, a second image enhancement profile for the second image set based on a determination that the second image set can be enhanced based on the extracted second image parameters;
modifying, by using the third AI-based model, the images in the second image set based on the second image enhancement profile; and
performing the second defect detection process on the modified second image set to detect previously undetected defects in the modified second image set.

6. The method of claim 5, wherein:
the first image parameters of each image in the first image set includes a resolution, a noise-level, and scale information of a corresponding input image in the first image set,
the second of image parameters of each image in the second image set includes a resolution, a noise-level, and scale information of a corresponding input image in the second image set, and
the extracted first image parameters are different from the extracted second image parameters.

7. The method of claim 1, further comprising:
determining, by using the second AI-based model, whether the modified first image set can be further enhanced, wherein the modified first image set includes only input images for which defects have not been detected in the second defect detection process;
re-generating, by using the second AI-based model, based on a determination that the modified first image set can be further enhanced, a third image enhancement profile for the modified first image set by extracting the first image parameters from the modified first image set;
re-modifying, by using the third AI-based model, the modified first image set based on the regenerated image enhancement profile; and
performing a third defect detection process on the re-modified first image set to detect previously undetected defects in the input images in the re-modified first image set.

8. The method of claim 1, wherein:
the defects include holes, breaks, bridges, gaps, line collapse, missing pillars, and/or scum, in a wafer lithographic pattern, and
the wafer lithographic pattern includes line spaces, holes, or pillars in the images of the semiconductor wafers.

9. The method of claim 1, wherein:
the first AI-based model and the second AI-based model respectively comprise rule-based learning models, and
the third AI-based model corresponds a neural network model configured to perform image enhancement.

10. An apparatus for multi-level defect detection in semiconductor wafers, the system comprising:
a memory; and
one or more processors communicatively coupled with the memory, wherein the memory stores instructions configured to cause the one or more processors to perform a process comprising:
receiving input images of the semiconductor wafers;
performing, by using a first AI-based model, a defect detection process on the input images to detect defects in the input images;
based on a result of the defect detection process, forming a first image set to include those of the input images for which no defects were detected and forming a second image set to include those of the input images for which any defects were detected;
generating, by using the second AI-based model, an image enhancement profile for the first image set;
modifying, by using a third AI-based model, the first image set, the modifying performed according to the generated image enhancement profile; and
re-performing the defect detection process on the modified first image set to detect one or more previously undetected defects in the modified first image set.

11. The apparatus of claim 10, wherein the process further comprises:
extracting a first image parameters from the input images in the first image set based on an analysis of the first image set, the analysis performed by the first AI-based model; and
determining, by using a second AI-based model, whether to perform image enhancement on the first image set, and
wherein the generating, by using the second AI-based model, an image enhancement profile for the first image set comprises
generating, by using the second AI-based model, the image enhancement profile for the first image set based on a determination that enhancement is to be performed on the first image set.

12. The apparatus of claim 10, wherein modifying the first image set comprises:
performing, by using the at least one third AI-based model and based on the generated image enhancement profile, a restoration process, a de-noising process, and/or a resolution enhancement process on the images in the first image set.

13. The apparatus of claim 10, wherein the process further comprises:
extracting second image parameters from the second image set based on an analysis of the second image set performed by the first AI-based model;
determining, by using the second AI-based model, whether to perform image enhancement on the second image set;
generating, by using the second AI-based model, an image enhancement profile for the second image set based on a determination to perform image enhancement on the second image set;
performing the image enhancement, by using the third AI-based model, on the second image set, the image enhancement based on the generated image enhancement profile of the second image set; and
re-performing the defect detection process on the enhanced second image set to detect previously undetected defects in the enhanced second image set.

14. The apparatus of claim 10, wherein:
the first image parameters include a resolution, a noise-level, scale information of each of the images in the first image set,
the second image parameters include a resolution, a noise-level, scale information of each of the images in the second image set, and
the extracted first image parameters is different from the extracted second image parameters.

15. The apparatus of claim 10, wherein the process further comprises:
determining, by using the second AI-based model, whether the enhanced first image is to be further enhanced, wherein the enhanced image set corresponds to images in which defects have not been detected in the second defect detection process;
re-generating, by using the second AI-based model, based on a determination that the modified first image set is to be further enhanced, an image enhancement profile for the enhanced first image set by extracting the first image parameters from the enhanced first image set;
re-enhancing, by using the third AI-based model, the enhanced first image set based on the regenerated image enhancement profile; and
re-performing the defect detection process on the re-enhanced first image set to detect previously undetected defects in the re-enhanced first image set.

16. The apparatus of claim 10, wherein:
the one or more defects include holes, breaks, bridges, gaps, line collapse, missing pillars, and/or scum, in wafer lithographic patterns, and
the wafer lithographic pattern include line spaces, holes, and/or pillars in the input images.

17. A method comprising:
applying a defect detection process to a set of images of semiconductor wafers;
dividing the input images into a first image set consisting of those of the images for which the defect detection process did not detect any defects and a second image set consisting of those of the images for which the detect detection process detected any defects;
determining a first image-enhancement profile based on the first image set and determining a second image-enhancement profile based on the second image set;
applying an image-enhancement process to the first image set according to the first image-enhancement profile;
applying the image-enhancement process to the second image set according to the second image-enhancement profile;
applying the defect detection process to the enhanced first image set and applying the defect detect process to the enhanced second image set; and
eliminating from the enhanced first image set any images thereof for which the second application of the defect detection process did not detect any defects, generating a new first image-enhancement profile for the thus-reduced enhanced first image set, and applying the defect detection process thereto.
